(19) United States
(12) Patent Application Publication
(10) Pub. No.: US 2026/0245539 A1
(43) Pub. Date: Aug. 20, 2026

(54) MULTI-PLATFORM DEVOPS VOICE ASSISTANT

(71) Applicant: American Megatrends International, LLC, Duluth, GA (US)

(72) Inventors: Manoj Kumar P, Panruti (IN); Venkatesan Balakrishnan, Chennai (IN); Joseprabu Inbaraj, Suwanee, GA (US)

(21) Appl. No.: 19/057,135

(22) Filed: Feb. 19, 2025

(51) Int. Cl. G10L 13/00; G06F 21/62; G10L 15/08; G10L 15/22; G10L 15/26

(52) U.S. Cl. CPC G10L 13/00; G06F 21/62; G10L 15/22; G10L 15/26; G10L 2015/088; G10L 2015/223

(57) ABSTRACT

One or more computing devices receive a voice command through a voice assistant device, the voice command requests a DevOps operation. The one or more computing devices convert the voice command to text using a voice processing component. The one or more computing devices generate a structured request based on the text, the structured request includes a command type and project identifier. The one or more computing devices retrieve encrypted access credentials from a database based on the project identifier. The one or more computing devices execute the DevOps operation on a target DevOps platform using the encrypted access credentials. The one or more computing devices provide an audio response through the voice assistant device indicating a result of the DevOps operation.

### BACKGROUND

### Field

The present disclosure relates generally to computer systems, and more particularly, to techniques of managing DevOps operations through voice commands across multiple DevOps platforms using voice assistant devices and services.

### Background

The statements in this section merely provide background information related to the present disclosure and may not constitute prior art.

DevOps teams rely heavily on manual processes and web interfaces to monitor and manage continuous integration/continuous deployment (CI/CD) pipelines across various version control systems like GitLab, GitHub, and Bitbucket. When pipeline failures occur, developers would receive email notifications and then need to manually log into the relevant platform's web interface, navigate to the specific project pipeline, locate the failed job, and manually initiate retry operations. This process can be time-consuming when managing multiple projects or dealing with recurring failures across different platforms.

The management of runner machines and their associated tags in CI/CD environments also requires significant manual intervention. Runner machines, which execute pipeline jobs, are typically assigned specific tags that are referenced in CI configuration files. When issues arose with specific tagged runners, developers may need to manually modify job configurations to use alternative runner tags since they often lacked direct access to fix issues on the runner machines themselves. This process involved checking available runners, editing CI configuration files, updating runner tags, and committing changes back to the repository-all through web interfaces or command line tools.

Voice assistant platforms like AMAZON ALEXA, GOOGLE ASSISTANT, and APPLE SIRI had become widely adopted for consumer applications, providing natural language interfaces for tasks like setting reminders, controlling smart home devices, and accessing information. These platforms offered SDK capabilities for third-party developers to create custom skills and actions. However, voice assistants are not utilized for DevOps management tasks, which remain dependent on traditional web interfaces and command line tools. While some automation tools existed for DevOps workflows, they typically require complex configuration and does not provide the convenience of natural language voice interaction for common pipeline management and monitoring tasks.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a system are provided. The system may include one or more computing devices. The one or more computing devices receive a voice command through a voice assistant device, the voice command requests a DevOps operation. The one or more computing devices convert the voice command to text using a voice processing component. The one or more computing devices generate a structured request based on the text, the structured request includes a command type and project identifier. The one or more computing devices retrieve encrypted access credentials from a database based on the project identifier. The one or more computing devices execute the DevOps operation on a target DevOps platform using the encrypted access credentials. The one or more computing devices provide an audio response through the voice assistant device indicating a result of the DevOps operation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system having a baseboard management controller (BMC) and a host computer.

FIG. 2 is a diagram illustrating a voice-enabled DevOps management system that enables users to manage DevOps pipelines through voice commands and receive audio responses across multiple DevOps platforms using various voice assistant devices.

FIG. 3 is a flow chart of a method for voice-enabled DevOps management performed by one or more computing devices.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

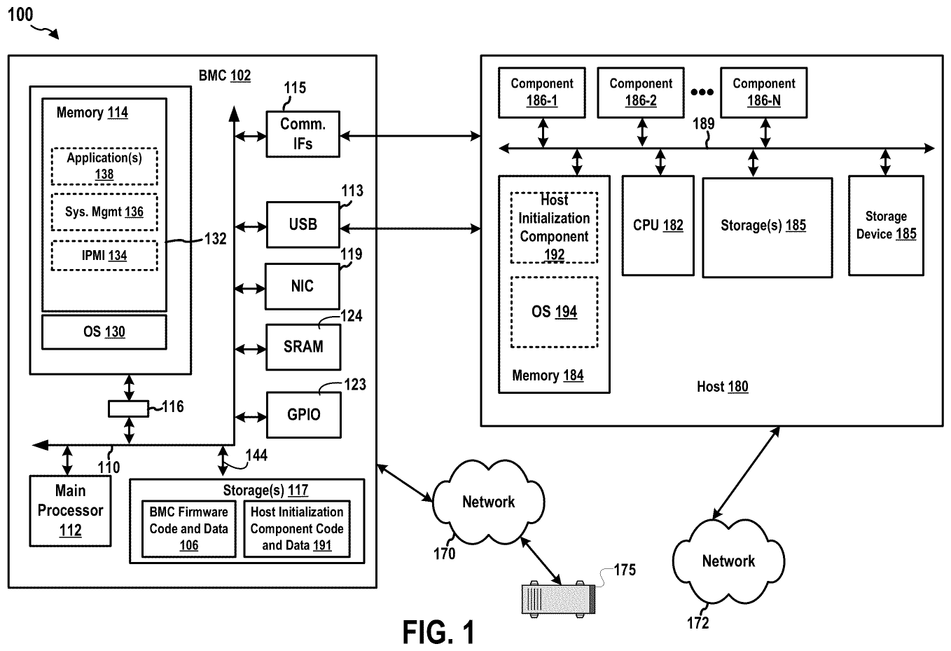

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

In modern software development environments, organizations frequently configure automated and scheduled pipelines on various projects that execute on weekly or monthly intervals. These pipelines, which run on DevOps platforms such as GitLab, GitHub, or Bitbucket, are essential for continuous integration and deployment workflows. When these pipelines fail, the system automatically triggers notification emails to the respective project owners. However, this automated notification system presents several operational challenges.

The primary challenge stems from the volume of notification emails generated by pipeline failures. Project owners receive numerous automated messages for various types of failures, making it difficult to identify and prioritize critical pipeline failures that require immediate attention. This email-based notification system, while functional, creates inefficiencies in tracking and responding to pipeline failures in a timely manner.

Furthermore, the current workflow for addressing pipeline failures requires multiple manual steps. When a failure occurs, developers must first log into the version control system through a web interface, navigate to the specific project pipeline, locate the failed job, and manually initiate a retry operation. This process becomes particularly time-consuming when managing multiple projects or dealing with recurring failures.

Another significant challenge relates to runner machine management. In typical continuous integration environments, each runner machine is assigned specific tags that are referenced in CI configuration files. These tags determine which runner executes particular pipeline jobs. When issues persist with a specific tagged runner machine, developers face additional complications. Since they often lack direct access to fix issues on the runner machines themselves, they must implement workarounds by manually modifying the job configuration to use alternative runner tags.

This runner tag modification process requires developers to perform several manual steps: checking available runner machines for the project, opening and editing the CI configuration file, updating the job runner tags to use available alternatives, and committing these changes back to the repository. After committing these changes, developers must then monitor the pipeline to verify the job executes successfully with the new runner configuration.

These manual intervention requirements create significant operational overhead and reduce the efficiency of the continuous integration process. The combination of email notification management, manual pipeline retry operations, and runner tag configuration changes represents a substantial time investment for development teams. These challenges highlight the need for a more efficient and automated approach to pipeline management and failure resolution.

The complexity of these manual processes is further compounded in large-scale development environments where multiple teams manage numerous projects across different version control platforms. The lack of a unified, automated solution for handling pipeline failures and runner configuration changes impacts team productivity and can delay critical deployment processes.

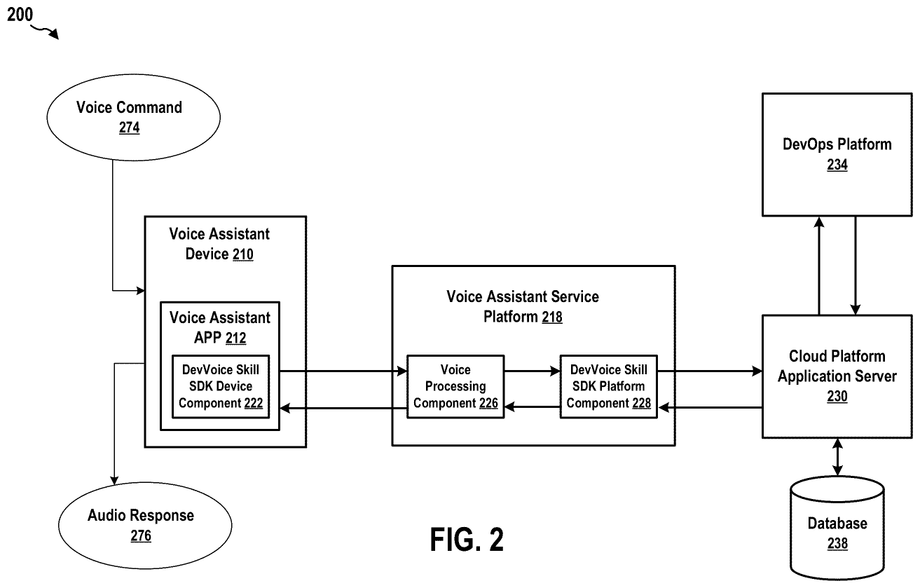

FIG. 2 is a diagram 200 illustrating a voice-enabled DevOps management system. The system enables users to manage DevOps pipelines through voice commands 274 and receive audio responses 276 across multiple DevOps platforms using various voice assistant devices.

The system includes a voice assistant device 210 which can be a smart speaker, smartphone, or smartwatch. The voice assistant device 210 includes a voice assistant application 212 that provides the basic voice interaction capabilities. A DevVoice skill SDK device component 222 is installed within the voice assistant application 212, enabling the device to process specialized DevOps-related voice commands.

The voice assistant service platform 218 serves as the cloud-based infrastructure that processes voice interactions. The platform includes a voice processing component 226 that handles speech recognition and text-to-speech conversion. The DevVoice skill SDK platform component 228 is installed on the voice assistant service platform 218 and contains the logic for interpreting DevOps-specific commands and mapping them to appropriate actions.

The cloud platform application server 230 acts as the central hub for processing DevOps requests and managing interactions with various DevOps platforms 234. When a user issues a voice command, such as requesting pipeline status or initiating a pipeline retry, the command flows from the voice assistant device 210 through the voice assistant service platform 218 to the cloud platform application server 230. The server then interfaces with the appropriate DevOps platform 234 (such as GitLab, GitHub, or Bitbucket) to execute the requested operation.

The system maintains user authentication and DevOps platform access credentials in an encrypted database 238. This database stores the necessary access tokens and configuration settings that enable secure communication between the cloud platform application server 230 and the various DevOps platforms 234.

The architecture supports bi-directional communication, allowing not only command execution but also proactive notifications. For example, when a pipeline fails, the system can generate an audio response 276 through the voice assistant device 210, alerting the user and offering options to address the failure. This automated notification and response capability significantly reduces the manual effort required for pipeline management and monitoring.

The voice-enabled DevOps management system provides a unified solution for managing multiple DevOps platforms through voice commands. The system implements a skill-based architecture where a DevVoice skill can be installed across different voice assistant platforms, enabling users to control and monitor their DevOps pipelines using natural language interactions.

Within the voice assistant application 212, running on the voice assistant device 210, the DevVoice skill SDK device component 222 is installed, which extends the device's capabilities to understand and process DevOps-specific voice commands 274. This component serves as the front-end interface between the user and the DevOps management system.

The voice assistant service platform 218 functions as the intermediary processing layer, hosting both the standard voice processing component 226 and the DevVoice skill SDK platform component 228. The voice processing component 226 handles the fundamental speech-to-text and text-to-speech conversions, while the DevVoice skill SDK platform component 228 contains the specialized logic for interpreting DevOps commands and mapping them to specific actions.

When a user issues a voice command 274, such as requesting to retry a failed pipeline or update runner tags, the command is processed through multiple stages. First, the voice assistant application 212 captures the audio input and forwards it to the voice assistant service platform 218. The voice processing component 226 converts the speech to text and identifies the intent through the DevVoice skill SDK platform component 228. This component then formats the request into a standardized API call that can be processed by the cloud platform application server 230.

The cloud platform application server 230 acts as the central orchestration point, maintaining connections with various DevOps platforms 234 such as GitLab, GitHub, and Bitbucket. The server authenticates requests using encrypted credentials stored in the database 238, then executes the appropriate API calls to the target DevOps platform 234. The response from the DevOps platform is processed and converted back into an audio response 276 that is delivered to the user through the voice assistant device 210.

This voice-enabled DevOps management system supports multiple voice commands for streamlining DevOps lifecycle management through the voice assistant device 210. When a user issues a voice command 274 to check a pipeline status, retry a failed pipeline, obtain project runner details, update job runner tags, or configure pipeline monitoring, the voice assistant application 212 receives this input through the voice assistant device 210. For example, the voice-enabled DevOps management system enables users to manage DevOps pipelines through the voice commands 274 and receive the audio responses 276. When a user issues a voice command, such as “Get me the project 103 latest pipeline status,” the voice assistant device 210 captures this input through the voice assistant application 212. The voice assistant application 212 includes the DevVoice skill SDK device component 222 that processes these specialized DevOps commands and sends the voice commands to the voice processing component 226.

The voice processing component 226 within the voice assistant service platform 218 processes these voice commands by converting speech to text and identifying the command intent. The DevVoice skill SDK platform component 228, installed on the voice assistant service platform 218, contains specialized mapping logic that translates these interpreted commands into structured API requests for the cloud platform application server 230.

For pipeline status monitoring, when a user requests the status of a specific project pipeline, the cloud platform application server 230 retrieves the necessary authentication credentials from the database 238 and communicates with the appropriate DevOps platform 234. The server then returns the status information, which is converted back to an audio response 276 delivered through the voice assistant device 210.

The system provides automated pipeline failure tracking and notification capabilities. Users can configure specific pipelines for failure monitoring through voice commands. When a monitored pipeline fails, the cloud platform application server 230 initiates a proactive notification through the voice assistant device 210, offering options to retry the failed pipeline or schedule automatic retries at specified intervals.

The DevVoice skill SDK device component 222, installed within the voice assistant application 212, enables advanced runner management features. Users can vocally request available runner details for a project and update runner tags when needed. This eliminates the manual process of modifying CI configuration files and committing changes to the repository. The cloud platform application server 230 handles these runner management operations by interfacing with the appropriate DevOps platform 234 using stored access credentials from the database 238.

Through this architecture, the system provides a unified voice interface for managing multiple DevOps platforms, significantly reducing the manual effort required for pipeline management and monitoring. The integration between the voice assistant device 210, voice assistant service platform 218, and cloud platform application server 230 creates a seamless experience for DevOps management through natural language interactions.

The voice-enabled DevOps management system implements a installation and registration process through voice assistant marketplaces. A user begins by accessing the marketplace associated with their voice assistant device 210. Through the marketplace interface, the user can search for and install the DevVoice skill, which integrates with the existing voice assistant application 212 on their device.

Upon installation, the DevVoice skill SDK device component 222 is embedded within the voice assistant application 212. This component extends the basic voice processing capabilities to include specialized DevOps management functions. The installation process triggers an initial registration workflow where users must provide essential configuration details to enable secure DevOps platform integration.

During the registration process, users are prompted to specify their organization's DevOps platform information. This includes identifying which DevOps platforms 234 (such as version control systems) are utilized within their organization. The system supports multiple major DevOps platforms, allowing users to configure access to various platforms through a single plugin installation.

Further, users provide access tokens or similar authentication mechanisms required by their DevOps platforms 234. These credentials are necessary for the cloud platform application server 230 to execute commands on behalf of the user. To maintain security, the system never stores authentication tokens in their original form. Instead, all access credentials are encrypted before being stored in the database 238.

The registration workflow implements a multi-step verification process to validate the provided DevOps platform credentials. The cloud platform application server 230 attempts to establish connections with each configured DevOps platform 234 using the supplied credentials. This verification step helps identify any configuration issues before completing the registration process.

Once registration is successfully completed, the DevVoice skill SDK platform component 228 on the voice assistant service platform 218 becomes fully activated for the user's account. This activation enables the processing of voice commands 274 related to DevOps management tasks. Users can then begin issuing voice commands through their voice assistant device 210 to monitor pipeline status, retry failed jobs, manage runner configurations, and receive audio responses 276 confirming their requested actions.

The system maintains the encrypted credentials in the database 238 for subsequent operations. When a user issues a voice command 274, the cloud platform application server 230 retrieves and decrypts the necessary credentials to authenticate requests to the appropriate DevOps platform 234. This secure credential management approach enables seamless interaction with multiple DevOps platforms while maintaining robust security practices.

The voice-enabled DevOps management system implements specialized features for managing runner configurations and pipeline monitoring through voice commands. These features address common challenges in DevOps environments where manual intervention is typically required for runner tag updates and pipeline failure management.

The system enables users to retrieve and modify runner configurations through natural language interactions. When a user issues a voice command 274 such as “Get the project 101 configured runner tags” to the voice assistant device 210, the voice assistant application 212 processes this request through the DevVoice skill SDK device component 222, which sends the speech input to the voice processing component 226. The voice processing component 226 converts this speech input to a structured command that the DevVoice skill SDK platform component 228 can interpret. The cloud platform application server 230 then queries the appropriate DevOps platform 234 to retrieve the configured runner tags, such as “new tag,” “old tag,” and “latest tag.” This information is converted back to an audio response 276 delivered through the voice assistant device 210.

Following the retrieval of runner tags, users can modify runner configurations using voice commands. For instance, when a user issues a command to “Update the runner tag as new tag for the build job,” the system processes this request through the same command chain. The cloud platform application server 230 executes the tag update operation on the DevOps platform 234 and automatically commits these changes to the appropriate branch. This voice-driven approach eliminates the need for manual editing of CI configuration files and repository commits.

The system also provides advanced pipeline monitoring capabilities through voice configuration. Users can establish pipeline failure tracking by issuing commands such as “Configure the pipeline to track failures for project 163.” When this command is processed, the cloud platform application server 230 sets up monitoring rules for the specified project pipeline. Upon successful configuration, the system confirms the setup through an audio response 276.

The pipeline monitoring system has proactive notification capability. When a monitored pipeline fails, the cloud platform application server 230 initiates an automated notification through the voice assistant device 210. The notification is delivered as an audio response 276, alerting users to the failure and offering immediate remediation options. For example, the voice assistant device 210 may ask “Shall I retry the pipeline?” Users can then respond with a simple affirmative voice command to trigger a pipeline retry operation.

The voice-enabled DevOps management system may implements the following workflow for processing voice commands and executing DevOps operations. When a user issues a voice command 274 through the voice assistant device 210, such as “retry the job pipeline for project 123,” the voice assistant application 212 initially captures this audio input. The voice assistant device 210 can be implemented as a smart speaker, smartwatch, or through a companion mobile application.

The voice command 274 is transmitted to the voice assistant service platform 218, where the voice processing component 226 performs speech recognition to convert the audio input into text. The voice processing component 226 utilizes built-in capabilities of the service platform to handle this conversion. After speech-to-text conversion, the system identifies command keywords such as “retry pipeline,” “configure pipeline,” or “update runner tag” to generate a structured JSON request.

The DevVoice skill SDK platform component 228 processes this JSON request through specialized functions developed for each command type. For example, a dedicated function may handle pipeline retry operations, while separate functions manage pipeline configuration and runner tag updates. These functions implement parameter validation logic to verify all required inputs are provided. When necessary information is missing, such as a project ID for a retry operation, the system generates follow-up questions through an audio response 276 to obtain the required parameters.

The cloud platform application server 230 receives the processed request containing the command type, project identifier, and target DevOps platform 234 information. The server may maintain REST API endpoints specifically designed for each supported DevOps platform 234. These endpoints implement the necessary API calls using platform-specific interfaces, such as GitLab API for GitLab environments. To execute these operations, the server retrieves encrypted access tokens from the database 238, which stores credentials provided during the initial skill registration process.

After executing the requested operation on the target DevOps platform 234, the cloud platform application server 230 generates a response indicating the operation's status. This response is formatted according to the voice assistant service platform's specifications and converted back to speech through the voice processing component 226. The system then delivers this audio response 276 to the user through the voice assistant device 210, completing the command execution cycle.

The workflow supports various DevOps management scenarios through voice interaction. For pipeline monitoring, users can configure failure tracking through voice commands, and the system will proactively notify users through the voice assistant device 210 when issues occur. For runner management, users can vocally request available runner details and update runner tags without manually editing configuration files. This comprehensive voice-enabled workflow significantly reduces the manual effort required for DevOps pipeline management and monitoring tasks.

The voice-enabled DevOps management system implements a structured JSON-based communication protocol between the voice processing component 226 and the DevVoice skill SDK platform component 228. This protocol enables accurate translation of voice commands into executable DevOps operations and conversion of operation results back into voice responses.

When the voice processing component 226 receives a voice command 274 and converts it to text, it generates a tokenized JSON request that contains multiple fields essential for DevOps operation execution. The JSON request includes tokens for a command_type field that specifies the intended DevOps operation (such as “retry_pipeline”, “configure_pipeline”, or “update_runner_tag”), a project_id field that identifies the target project, and a devops_platform field that indicates which DevOps platform 234 (such as version control system) should execute the operation, etc.

For example, when a user issues a voice command to retry a pipeline, the voice processing component 226 generates a JSON request structured as follows:

```
{
  “command_type”: “retry_pipeline”,
  “project_id”: “105”,
  “devops_platform”: “gitlab”
}
```

The DevVoice skill SDK platform component 228 processes this JSON request and validates the required parameters. If any required parameters are missing, the component generates a follow-up question request that is sent back to the voice processing component 226 for conversion into an audio response 276.

After the DevOps operation is executed by the cloud platform application server 230, the DevVoice skill SDK platform component 228 generates a tokenized JSON response. This response may include tokens for a status field indicating the operation result (such as “success” or “failed”), a message field containing detailed information about the operation outcome, and any additional data fields specific to the operation type.

The JSON response structure for a successful pipeline retry operation might appear as:

```
{
  “status”: “success”,
  “message”: “Pipeline retry initiated successfully”,
  “project_id”: “105”,
  “execution_status”: “running”
}
```

The voice processing component 226 receives this JSON response and converts the message field content into natural language suitable for voice output. This conversion considers the context of the original command and generates appropriate verbal confirmations or status updates that are delivered to the user through the voice assistant device 210 as an audio response 276.

This JSON-based communication protocol between the voice processing component 226 and the DevVoice skill SDK platform component 228 provides a standardized method for translating voice commands into DevOps operations while maintaining context and enabling meaningful audio responses to the user.

The DevVoice skill SDK implements a multi-component architecture that enables intelligent processing of voice commands for DevOps operations. The architecture comprises the DevVoice skill SDK device component 222 installed within the voice assistant application 212, and the DevVoice skill SDK platform component 228 deployed on the voice assistant service platform 218. These components work in concert to process voice commands 274 and generate appropriate audio responses 276 for DevOps management tasks.

The DevVoice skill SDK platform component 228 implements custom skill code that maps user intents derived from voice commands to specific endpoint definitions. When a user issues a voice command 274 through the voice assistant device 210, the voice processing component 226 converts the speech to text and identifies the command intent. The DevVoice skill SDK platform component 228 then maps this intent to a corresponding endpoint in the cloud platform application server 230 that can execute the requested DevOps operation on the target DevOps platform 234.

The skill SDK implements comprehensive input validation logic to maintain operational integrity. When processing a voice command 274, the DevVoice skill SDK platform component 228 verifies that all required parameters for the mapped endpoint are provided. For instance, when a user requests a pipeline retry operation, the SDK validates the presence of essential parameters such as the project identifier and target DevOps platform. If any required parameters are missing, the SDK generates follow-up questions that are converted to audio responses 276 and delivered through the voice assistant device 210, creating an interactive dialogue to collect necessary information.

The DevVoice skill SDK maintains organizational context by managing DevOps platform authentication and configuration details. During the initial setup, the SDK collects and securely stores organizational information, DevOps platform credentials, and related configuration data in the database 238. This information is encrypted and retrieved by the cloud platform application server 230 when executing DevOps operations. The SDK's organization-aware architecture enables it to properly route commands to the appropriate DevOps platform 234 while maintaining secure access controls.

Through this architecture, the DevVoice skill SDK transforms natural language commands into precise DevOps operations while maintaining security and operational context. The SDK's intelligent intent mapping, parameter validation, and organization awareness capabilities enable users to manage complex DevOps workflows through intuitive voice interactions.

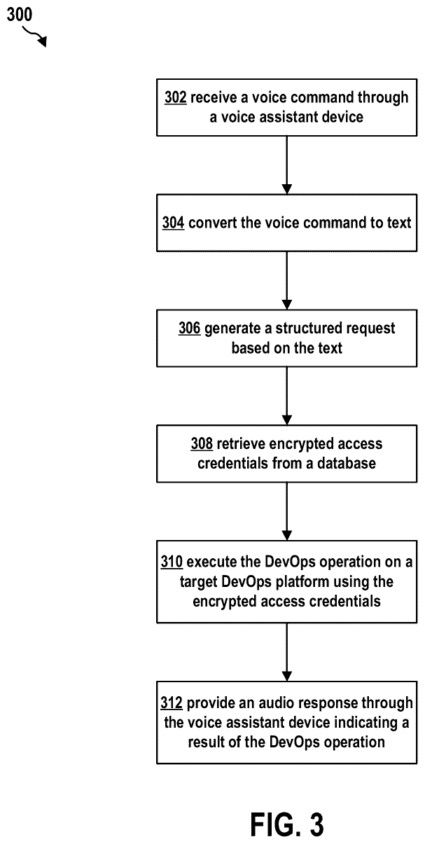

FIG. 3 is a flow chart 300 of a method for voice-enabled DevOps management. The method may be performed by one or more computing devices (e.g., the voice assistant device 210, the cloud platform application server 230 and voice assistant service platform 218).

In operation 302, the one or more computing devices receive a voice command through a voice assistant device, the voice command requesting a DevOps operation. In operation 304, the one or more computing devices convert the voice command to text using a voice processing component. In operation 306, the one or more computing devices generate a structured request based on the text, the structured request including a command type and project identifier. In operation 308, the one or more computing devices retrieve encrypted access credentials from a database based on the project identifier. In operation 310, the one or more computing devices execute the DevOps operation on a target DevOps platform using the encrypted access credentials. In operation 312, the one or more computing devices provide an audio response through the voice assistant device indicating a result of the DevOps operation.

To execute the DevOps operation, the one or more computing devices determine the target DevOps platform from multiple supported DevOps platforms based on stored configuration information and select an application programming interface (API) endpoint corresponding to the determined target DevOps platform.

To generate the structured request, the one or more computing devices identify command keywords in the text, map the command keywords to a DevOps operation type, and validate presence of required parameters for the DevOps operation type. When a required parameter is missing from the voice command, the one or more computing devices generate a follow-up question requesting the missing parameter, convert the follow-up question to a second audio response, output the second audio response through the voice assistant device, and receive a second voice command providing the missing parameter.

In certain configurations, the DevOps operation comprises at least one of: retrieving a pipeline status for a specified project, retrying a failed pipeline, obtaining project runner details, updating job runner tags, and configuring pipeline failure monitoring.

To configure pipeline monitoring, the one or more computing devices receive a voice command to configure pipeline monitoring for a specified project, set up monitoring rules for the specified project on the target DevOps platform, detect a pipeline failure for the specified project, generate a notification of the pipeline failure, convert the notification to an audio alert, output the audio alert through the voice assistant device, and receive a voice response to retry the failed pipeline.

To execute runner tag operations, the one or more computing devices retrieve runner tag configurations for a specified project, receive a voice command to update a runner tag, modify the runner tag configurations based on the voice command, and automatically commit the modified runner tag configurations to a repository on the target DevOps platform.

The one or more computing devices install a DevOps skill component within a voice assistant application on the voice assistant device, receive organization credentials and DevOps platform information during a registration process, encrypt the organization credentials, and store the encrypted organization credentials and DevOps platform information in the database.

To generate the structured request, the one or more computing devices generate a JSON request including a first field specifying the DevOps operation, a second field identifying a target project, and a third field indicating the target DevOps platform.

To provide the audio response, the one or more computing devices receive a JSON response including operation status and result details, convert the operation status and result details to natural language text, and convert the natural language text to the audio response.

In certain configurations, the voice assistant device comprises at least one of: a smart speaker, a smartphone running a voice assistant application, and a smartwatch running a voice assistant application.

The one or more computing devices maintain separate connections to multiple DevOps platforms through a cloud platform application server, store access credentials for each DevOps platform in encrypted form, and select appropriate access credentials based on the target DevOps platform when executing the DevOps operation.

The voice assistant device 210, voice assistant service platform 218, and cloud platform application server 230, etc. shown in FIG. 2 and the one or more computing devices referenced in the method of FIG. 3 may be implemented using the computer system 100 architecture shown in FIG. 1. For example, the host computer 180 with its host CPU 182, host memory 184, storage device(s) 185, and component devices 186-1 to 186-N may implement the processing and storage capabilities required for the voice assistant device 210 to process voice commands and communicate with the voice assistant service platform 218. Similarly, the host computer 180 may implement the cloud platform application server 230 functionality for processing DevOps requests and interfacing with various DevOps platforms 234 through its network interfaces and component devices. The BMC 102 with its processor 112, memory 114, and network interfaces may provide the out-of-band management capabilities needed to securely store encrypted credentials and manage communications between the voice assistant components and DevOps platforms.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
receiving a voice command through a voice assistant device, the voice command requesting a DevOps operation;
converting the voice command to text using a voice processing component;
generating a structured request based on the text, the structured request including a command type and project identifier;
retrieving encrypted access credentials from a database based on the project identifier;
executing the DevOps operation on a target DevOps platform using the encrypted access credentials; and
providing an audio response through the voice assistant device indicating a result of the DevOps operation.

2. The method of claim 1, wherein executing the DevOps operation comprises:
determining the target DevOps platform from multiple supported DevOps platforms based on stored configuration information; and
selecting an application programming interface (API) endpoint corresponding to the determined target DevOps platform.

3. The method of claim 1, wherein generating the structured request comprises:
identifying command keywords in the text;
mapping the command keywords to a DevOps operation type; and
validating presence of required parameters for the DevOps operation type.

4. The method of claim 3, further comprising:
when a required parameter is missing from the voice command:
generating a follow-up question requesting the missing parameter;
converting the follow-up question to a second audio response;
outputting the second audio response through the voice assistant device; and
receiving a second voice command providing the missing parameter.

5. The method of claim 1, wherein the DevOps operation comprises at least one of:
retrieving a pipeline status for a specified project;
retrying a failed pipeline;
obtaining project runner details;
updating job runner tags; and
configuring pipeline failure monitoring.

6. The method of claim 1, further comprising:
receiving a voice command to configure pipeline monitoring for a specified project;
setting up monitoring rules for the specified project on the target DevOps platform;
detecting a pipeline failure for the specified project;
generating a notification of the pipeline failure;
converting the notification to an audio alert;
outputting the audio alert through the voice assistant device; and
receiving a voice response to retry the failed pipeline.

7. The method of claim 1, wherein executing the DevOps operation comprises:
retrieving runner tag configurations for a specified project;
receiving a voice command to update a runner tag;
modifying the runner tag configurations based on the voice command; and
automatically committing the modified runner tag configurations to a repository on the target DevOps platform.

8. The method of claim 1, further comprising:
installing a DevOps skill component within a voice assistant application on the voice assistant device;
receiving organization credentials and DevOps platform information during a registration process;
encrypting the organization credentials; and
storing the encrypted organization credentials and DevOps platform information in the database.

9. The method of claim 1, wherein generating the structured request comprises:
generating a JSON request including:
a first field specifying the DevOps operation;
a second field identifying a target project; and
a third field indicating the target DevOps platform.

10. The method of claim 1, wherein providing the audio response comprises:
receiving a JSON response including operation status and result details;
converting the operation status and result details to natural language text; and
converting the natural language text to the audio response.

11. The method of claim 1, wherein the voice assistant device comprises at least one of:
a smart speaker;
a smartphone running a voice assistant application; and
a smartwatch running a voice assistant application.

12. The method of claim 1, further comprising:
maintaining separate connections to multiple DevOps platforms through a cloud platform application server;
storing access credentials for each DevOps platform in encrypted form; and
selecting appropriate access credentials based on the target DevOps platform when executing the DevOps operation.

13. A system, including one or more computing devices, comprising:
a memory; and
at least one processor coupled to the memory and configured to:
receive a voice command through a voice assistant device, the voice command requesting a DevOps operation;
convert the voice command to text using a voice processing component;
generate a structured request based on the text, the structured request including a command type and project identifier;
retrieve encrypted access credentials from a database based on the project identifier;
execute the DevOps operation on a target DevOps platform using the encrypted access credentials; and
provide an audio response through the voice assistant device indicating a result of the DevOps operation.

14. The system of claim 13, wherein to execute the DevOps operation, the at least one processor is further configured to:
determine the target DevOps platform from multiple supported DevOps platforms based on stored configuration information; and
select an application programming interface (API) endpoint corresponding to the determined target DevOps platform.

15. The system of claim 13, wherein to generate the structured request, the at least one processor is further configured to:
identify command keywords in the text;
map the command keywords to a DevOps operation type; and
validate presence of required parameters for the DevOps operation type.

16. The system of claim 15, wherein the at least one processor is further configured to:
when a required parameter is missing from the voice command:
generate a follow-up question requesting the missing parameter;
convert the follow-up question to a second audio response;
output the second audio response through the voice assistant device; and
receive a second voice command providing the missing parameter.

17. The system of claim 13, wherein the DevOps operation comprises at least one of:
retrieving a pipeline status for a specified project;
retrying a failed pipeline;
obtaining project runner details;
updating job runner tags; and
configuring pipeline failure monitoring.

18. The system of claim 13, wherein the at least one processor is further configured to:
receive a voice command to configure pipeline monitoring for a specified project;
set up monitoring rules for the specified project on the target DevOps platform;
detect a pipeline failure for the specified project;
generate a notification of the pipeline failure;
convert the notification to an audio alert;
output the audio alert through the voice assistant device; and
receive a voice response to retry the failed pipeline.

19. The system of claim 13, wherein to execute the DevOps operation, the at least one processor is further configured to:
retrieve runner tag configurations for a specified project;
receive a voice command to update a runner tag;
modify the runner tag configurations based on the voice command; and
automatically commit the modified runner tag configurations to a repository on the target DevOps platform.

20. A non-transitory computer-readable medium storing computer executable code for operating one or more computing devices, comprising code to:
receive a voice command through a voice assistant device, the voice command requesting a DevOps operation;
convert the voice command to text using a voice processing component;
generate a structured request based on the text, the structured request including a command type and project identifier;
retrieve encrypted access credentials from a database based on the project identifier;
execute the DevOps operation on a target DevOps platform using the encrypted access credentials; and
provide an audio response through the voice assistant device indicating a result of the DevOps operation.
